(19) United States
(12) Patent Application Publication
(10) Pub. No.: US 2011/0136761 A1
(43) Pub. Date: Jun. 9, 2011

(54) Vapour of a Citrus Essential Oil Blend and Its Antimicrobial Properties

(75) Inventors: Carol Phillips, Northampton (GB); Katie Laird, Northampton (GB)

(73) Assignee: THE UNIVERSITY OF NORTHAMPTON, Northampton (GB)

(21) Appl. No.: 12/995,122

(22) PCT Filed: May 28, 2009
(86) PCT No.: PCT/GB2009/001345

§ 371 Date: Feb. 8, 2011

(30) Foreign Application Priority Data
May 30, 2008 (GB) 0809935.0

(51) Int. Cl. A01N 55/10; A01P 1/00; A01P 3/00

(52) U.S. Cl. 514/63

(57) ABSTRACT

A vapour of a blend comprising the oil of orange and the oil of bergamot, a process for its preparation and its use as an antimicrobial. The vapour has been found to be particularly useful on food contaminated with microorganisms without affecting the sensory properties of the food.

### CROSS-REFERENCE TO RELATED APPLICATIONS

This application is a filing under 35 U.S.C. 371 of International Application No. PCT/GB2009/001345 filed May 28, 2009 entitled “Vapour of a Citrus Essential Oil Blend and its Antimicrobial Properties,” claiming priority of Great Britain Application No. 0809935.0 filed May 30, 2008, which applications are incorporated by reference herein in their entirety.

### FIELD OF INVENTION

The present invention relates to the vapour of a blend of essential oils and the antimicrobial properties of the vapour. The vapours have application within the fresh/organic fruit, vegetable and salad sector of the food industry, the horticultural industry and the clinical arena.

### BACKGROUND OF THE INVENTION

Between 1992 and 2006, 2,274 foodborne outbreaks of food poisoning were reported in England and Wales, 4% of which were associated with the consumption of prepared salads. Fresh salad, vegetables, or fruit may become contaminated from environmental sources, and only in recent years has the association of foods from origins other than animal been associated with foodborne illness, demonstrating that health problems can arise from consumption of contaminated salads, fruits and vegetables (as reported in Little, C. L. and Gillespie, I. A. (2008) Prepared salads and public health. Journal of Applied Microbiology, In Press). This is of concern because the organic sector of the food market has a retail value of £223 million and is one of the fastest growing sectors with an increase of 30% per annum from the 1990's to 2000. Although this has now began to slow to 15%, thought to be due to downward price pressures from the supermarket supply chain. Yet if the Organic Action Plan Target plan is to be met with 70% of the indigenous organic products to be sourced from the UK by 2010, progress within the sector is required, including a natural antimicrobial that can go some way to reducing the contamination and post harvest decay of salads, fruits and vegetables (see DEFRA (2006) The UK organic vegetable market (2004-2005 season)).

The numbers of antibiotic resistant bacteria are on the increase and an alternative to antibiotics needs to be found. There were 1,087 reported cases of MRSA bloodstream infections in England during the October to December quarter of 2007, showing a 0.6% increase on the previous quarter (Health Protection Agency (2008) Latest figures show MRSA bloodstream infections plateau. Available from. www.hpa.org.uk). In 2005 in the UK there were 7,066 reported cases of Enterococcus spp. bacteraemia; 28% of all cases were antibiotic resistant (Health Protection Agency (2007) Bacteraemia. available from. www.hpa.org.uk/cdr/pages/bacteraemia.htm#entero). The risk of death from vancomycin resistant Enterococcus (VRE) is 75% compared with 45% for individuals infected with a vancomycin susceptible strain (Bearman, G. M. L. and Wenzel, R. P. (2005) Bacteraemias: A leading cause of death. Archives of Medical Research, 36, (6) 646-659). This is mirrored in the USA: in a fifteen year period there was a 20-fold increase in VRE associated with nosocomial infections reported to CDC's National Nosocomial Infections Surveillance (NNIS) (National Nosocomial Infection Surveillance (2004) System report, data summary from January 1992 through June 2004, issued October 2004. A report from the NNIS System. American Journal of Infection Control, (32) 470-485).

Essential oils (EOs) per se and their antimicrobial properties have been reviewed extensively and natural plant compounds such as spices, herbs, and essential oils are known to inhibit growth of food-poisoning bacteria (Tassou, C. C. and Nychas, G. J. E. (1995) Antimicrobial activity of the essential oil of mastic gum (Pistacia lentiscus var. chia) on Gram positive and Gram negative bacteria in broth and in Model Food System. International Biodeterioration & Biodegradation, 36, (3-4) 411-420, Smith-Palmer, Stewart and Fyfe (1998) Antimicrobial properties of plant essential oils and essences against five important food-borne pathogens. Letters in Applied Microbiology, 26, (2) 118-122, Tassou, C., Koutsoumanis, K. and Nychas, G. J. E. (2000) Inhibition of Salmonella enteritidis and Staphylococcus aureus in nutrient broth by mint essential oil. Food Research International, 33, (3-4) 273-280, Inouye, S., Takizawa, T. and Yamaguchi, H. (2001) Antibacterial activity of essential oils and their major constituents against respiratory tract pathogens by gaseous contact. Journal of Antimicrobial Chemotherapy, 47, 565-573, Burt, S. (2004) Essential oils: their antibacterial properties and potential applications in foods—a review. International Journal of Food Microbiology, 94, (3) 223-253 and Lanciotti, R., Gianotti, A., Patrignani, F., Belletti, N., Guerzoni, M. E. & Gardini, F. (2004) Use of natural aroma compounds to improve shelf-life and safety of minimally processed fruits. Trends in Food Science & Technology, 15, (3-4) 201-208). The antimicrobial properties of EOs vapours, however, have been relatively unexplored.

Citrus essential oils/vapours and their components are recognised as “Generally Recognised As Safe” (GRAS) by the FDA, suggesting that they can have usage within both the clinical and food arena. Preliminary studies have shown bergamot, lemon, and orange alone in vapour form to have antimicrobial properties against a range of Gram-negative and Gram-positive bacteria including Campylobater jejuni, Escherichia coli O157, Listeria monocytogenes, Bacillus cereus and Staphylococcus aureus (K. Fisher, et. al., (2007), The Survival of three strains of Arcobacter butzleri in the presence of lemon, orange and bergamot essential oils and their components in vitro and on food, Letters in Applied Microbiology, 44, (5), 495-499 and K. Fisher, C. A. Phillips (2006) The effect of lemon, orange and bergamot essential oils and their components on the survival of Campylobacter jejuni, Escherichia coli O157, Listeria monocytogenes, Bacillus cereus and Staphylococcus aureus in vitro and in food systems Journal of Applied Microbiology 101 (6), 1232-1240).

A review of potential antimicrobial uses of essential oils in food can be found in Trends in Food Science & Technology Volume 19, Issue 3, March 2008, pages 156-164 (Katie Fisher and Carol Phillips, Potential antimicrobial uses of essential oils in food: is citrus the answer?).

### SUMMARY OF INVENTION

We have discovered a vapour of a blend of citrus essential oils that is antimicrobial against a range of Gram-positive and Gram-negative bacteria, including antibiotic-resistant strains, and that is also active against bacterial spores. The vapour can be used on food and no sensory changes occur. The vapour can also be used to control food contaminated with microorganisms.

The vapour acts on surfaces including those of fresh food produce to reduce contamination by pathogens.

It is to be understood that the term “antimicrobial” as used in this specification, means “capable of destroying or inhibiting the growth of microorganisms.” The microorganism may be a bacterium, virus, rickettsia, yeast, or fungus.

According to a first aspect of the present invention, there is provided a vapour of a blend comprising the oil of orange and the oil of bergamot. By “oil of orange” or “orange oil,” it is meant Citrus sinensis. By “oil of bergamot” or “bergamot oil,” it is meant Citrus bergamia.

In an embodiment, the blend consists of orange oil and bergamot oil. In other words, the orange oil and the bergamot oil are the only two components in the blend.

Suitably, the orange oil and bergamot oil are present in the blend in a ratio of 1:1 volume:volume.

In an embodiment, the vapour comprises the following components: methanol, ethanol, acetone, isopropanol, fluoroacetic acid amine, trimethylsilyl fluoride, dimethylsilanediol, 3-heptanone, butylacetate, n-octanal, p-cymene, limonene, alpha-pinene, alpha-phellandrene, camphene, thujene, beta pinene, myrcene, carene, nonanal, nonanol, citral, linalool, 1-fluorododecane, bergamol and linalyl isobutyrate. Typically, the GCMS analysis of the vapour is as follows:

| Components | m/z** | Counts/min |
|---|---|---|
| Methanol | 33 | 1279 |
| Ethanol | 47 | 391 |
| Acetone | 59 | 71682 |
| Isopropanol | 60 | 2236 |
| Fluoroacetic acid amine | 77 | 4505 |
| Trimethylsilyl fluoride | 92 | 58* |
| Dimethylsilanediol | 92 | 58* |
| 3-heptanone | 114 | 43 |
| Butylacetate | 116 | 110 |
| n-octanal | 128 | 57 |
| p-cymene | 134 | 342 |
| Limonene | 136 | 54440* |
| Alpha-pinene | 136 | 54440* |
| Alpha-phellandrene | 136 | 54440* |
| Camphene | 136 | 54440* |
| Thujene | 136 | 54440* |
| Beta pinene | 136 | 54440* |
| Myrcene | 136 | 54440* |
| Carene | 136 | 54440* |
| Nonanal | 142 | 36 |
| Nonanol | 144 | 36 |
| Citral | 154 | 186* |
| Linalool | 154 | 186* |
| 1-Fluorododecane | 188 | 27* |
| Bergamol | 196 | 26 |
| Linalyl isobutyrate | 224 | 25 |

*Combined peak for all components of the same molecular weight.
**m/z = mass to charge ratio

It has surprisingly been found that the vapour of the blend of oils has synergistic antimicrobial properties compared to the antimicrobial properties of the oils alone. Furthermore, when the vapour of the blend is exposed to foodstuffs, it does not affect the taste or smell of the food. Thus, the vapour may be useful as a food preservative as it has an antimicrobial effect without tainting the food. Furthermore, the vapour is effective at relatively high temperatures, for example, temperatures ranging from 25° C. to 50° C. Thus, the vapour may also be useful as an antimicrobial in greenhouses.

According to another aspect of the present invention, there is provided a process for preparing a vapour of a blend comprising the oil of orange and the oil of bergamot, the process comprising heating the blend. The blend may be heated to a temperature of around 30 to around 50° C. Suitably, the blend is heated for a period of time of ranging from 10 minutes to 20 minutes. Preferably, the blend is heated for 15 minutes. The vapour described above may be prepared according to this process.

In an embodiment, the liquid blend (i.e., prior to vapourisation) has the following major components according to GCMS:

| | | | Compound |
|---|---|---|---|
| | | | proportion |
| Compound | peak | peak | as % of |
| name | number | time | linalool |
| Methyl isobutyrate | 1 | 5.96 | 0.39 |
| 2-Pentanone | 2 | 6.06 | 0.88 |
| 3-Pentanone | 3 | 6.25 | 1.05 |
| 1R-alpha-Pinene or alpha-Pinene | 4 | 13.34 | 14.72 |
| Beta terpinene or beta-Phellandrene | 5 | 14.48 | 6.78 |
| alpha-Fenchene or Camphene or | 6 | 14.64 | 48.03 |
| beta-Pinene | | | |
| beta-Myrcene | 7 | 14.81 | 14.58 |
| Octanal | 8 | 15.24 | 1.25 |
| 3-Carene | 9 | 15.57 | 0.84 |
| D-Limonene | 10 | 16.11 | 822.01 |
| Gamma terpinene | 11 | 16.87 | 12.13 |
| Linalool | 12 | 17.88 | 100.00 |
| 1,2-Dihydrolinalool | 13 | 18.80 | 2.26 |
| alpha Terpineol | 14 | 20.60 | 4.86 |
| Decanal | 15 | 20.76 | 1.37 |
| Linalyl anthranilate | 16 | 21.95 | 274.99 |
| trans-Citral | 17 | 22.54 | 2.52 |
| Nerol acetate | 18 | 24.45 | 10.60 |
| Zingiberene | 19 | 26.42 | 2.51 |
| alpha-Farnesene | 20 | 27.68 | 3.17 |
| beta-Bisabolene | 21 | 27.89 | 5.84 |

According to another aspect of the present invention, there is provided the use of a vapour described above as an antimicrobial.

In an embodiment, the vapour is antimicrobial against bacteria. In an embodiment, the bacteria are antibiotic-resistant bacteria. In another embodiment, the bacteria are Gram-positive or Gram-negative bacteria.

In an embodiment, the bacteria are selected from Enterococcus faecium, Enterococcus faecalis, Arcobacter butzleri, Campylobacter jejuni, Escherichia coli, Listeria monocytogenes, Clostridium difficile, Staphylococcus aureus and MRSA. The Enterococcus faecium bacteria may be Enterococcus faecium NCTC 07171 and/or Enterococcus faecium NCTC 12202. The Enterococcus faecalis bacteria are Enterococcus faecalis NCTC 12697 and/or Enterococcus faecalis NCTC 12203. Enterococcus faecium NCTC 12202 and Enterococcus faecalis NCTC 12203 are examples of antibiotic-resistant bacteria.

In a further embodiment, the bacteria are spore-bearing bacteria. The vapour may be capable of destroying or inhibiting the growth of the spores, as well as being antimicrobial against the spore-bearing bacteria. In an embodiment, the spores are those of Clostridium difficile and/or Bacillus cereus.

In an embodiment, the bacteria are present in a foodstuff. Suitably, the vapour is used during the processing, packaging and/or storing of the foodstuff. In an embodiment, the foodstuff is salad, vegetables and/or fruit. The foodstuff may be subjected to the vapour for a period of time sufficient to have an antimicrobial effect on the foodstuff, for example, a period of time ranging from about 30 seconds to about 1 hour, more particularly from about 30 seconds to about 30 minutes, even more particularly for a period of time ranging from about 30 seconds to about 5 minutes. Typically, the foodstuff is subjected to the vapour for a period of time ranging from about 30 seconds to about 1 minute. Preferably, the foodstuff is subjected to the vapour for a period of time of about 45 seconds.

In an embodiment, the vapour is antimicrobial against fungi. In an embodiment, the fungi are selected from Aspergillus niger (for example, ATCC 9642), Penicillium chrysogenum (for example, ATCC 10106) and Alternaria alternate (for example, CABI 127255).

In an embodiment, the vapours are used for sanitisation of the air and/or equipment in a food industry environment.

In another embodiment, the vapours are used for sanitisation of the air and/or equipment in a clinical environment.

In an embodiment, the vapour is used for sanitisation of a surface. The surface may be exposed to the vapour for a period of time ranging from about 1 hour to about 48 hours, preferably from about 2 hours to about 36 hours, more preferably from about 5 hours to about 24 hours, and most preferably for about 24 hours.

According to another aspect of the present invention, there is provided the use of a vapour described above as an antimicrobial against plant pathogens. In an embodiment, the vapour is used in a greenhouse to protect the growing produce from plant pathogens. The plant pathogens may be, for example, bacterial, fungal or a mould.

### DETAILED DESCRIPTION OF THE INVENTION

The blend of the present invention comprises the oils of bergamot (Citrus bergamia) and orange (Citrus sinensis). In an embodiment, the oils of bergamot and orange are the only components of the blend. In an embodiment, the oils are present in a ratio of 1:1 v/v. The vapour of the blend may be prepared by heating 15 mg/l (15 mg of oil for every litre of air) of the blend for around 15-minutes. GC-MS head space analysis of the major components in the air after a 15-minute accumulation of the vapours from the blend was performed using the following technique.

A 50 ml syringe was used to extract air from the headspace and dissolved in 10 ml of water; 1 μl was injected (split injection 50:1) into a Perkin-Elmer ‘Turbomass’ GC-MS with an injector temperature of 250° C. The capillary column used was a Zebron ZB-5 with a column length of 30 m and diameter of 0.25 mm i.d., the carrier gas used was helium at a flow rate of 1 ml per min⁻¹. The initial temperature was 40° C. for 3 minutes, with a ramp temperature of 8° C. min⁻¹ and a final temperature of 240° C. for 2 minutes, this was carried out for a total of 30 minutes. For GC/MS detection, an electron impact (EI) ionisation system, with ionisation energy of 70 eV with a M/z range of 50 to 450 Da, with a scan interval of 0.55 seconds, interscan delay of 0.15 seconds and a solvent delay of 3 minutes. NIST05 and AMDIS32 libraries were used for identification.

The results are shown in Table 1.

TABLE 1

| Components | m/z** | Counts/min |
|---|---|---|
| Methanol | 33 | 1279 |
| Ethanol | 47 | 391 |
| Acetone | 59 | 71682 |
| Isopropanol | 60 | 2236 |
| Fluoroacetic acid amine | 77 | 4505 |
| Trimethylsilyl fluoride | 92 | 58* |
| Dimethylsilanediol | 92 | 58* |
| 3-heptanone | 114 | 43 |
| Butylacetate | 116 | 110 |
| n-octanal | 128 | 57 |
| p-cymene | 134 | 342 |
| Limonene | 136 | 54440* |
| Alpha-pinene | 136 | 54440* |
| Alpha-phellandrene | 136 | 54440* |
| Camphene | 136 | 54440* |
| Thujene | 136 | 54440* |
| Beta pinene | 136 | 54440* |
| Myrcene | 136 | 54440* |
| Carene | 136 | 54440* |
| Nonanal | 142 | 36 |
| Nonanol | 144 | 36 |
| Citral | 154 | 186* |
| Linalool | 154 | 186* |
| 1-Fluorododecane | 188 | 27* |
| Bergamol | 196 | 26 |
| Linalyl isobutyrate | 224 | 25 |

*Combined peak for all components of the same molecular weight.
**m/z is the mass to charge ratio

GC-MS analysis was also performed on the essential oil blend in liquid form, and the results are shown in Table 2.

TABLE 2
summary table of identified peaks and semi-quantification based on 3 replicate
analyses (relative to linalool)

| | | | | Calculated | Estimated |
|---|---|---|---|---|---|
| Compound | | peak | Compound | Concentration | concentration |
| name | peak | time | proportion | mg per mL | mg/mL in e.oil |
| Methyl isobutyrate | 1 | 5.96 | 0.39 | — | 0.32 |
| 2-Pentanone | 2 | 6.06 | 0.88 | — | 0.73 |
| 3-Pentanone | 3 | 6.25 | 1.05 | — | 0.86 |
| 1R-alpha-Pinene or alpha- | 4 | 13.34 | 14.72 | — | 12.13 |
| Pinene | | | | | |
| Beta terpinene or beta- | 5 | 14.48 | 6.78 | — | 5.59 |
| Phellandrene | | | | | |
| alpha-Fenchene or Camphene | 6 | 14.64 | 48.03 | — | 39.58 |
| or beta-Pinene | | | | | |
| beta-Myrcene | 7 | 14.81 | 14.58 | — | 12.02 |
| Octanal | 8 | 15.24 | 1.25 | — | 1.03 |
| 3-Carene | 9 | 15.57 | 0.84 | — | 0.70 |
| D-Limonene | 10 | 16.11 | 822.01 | 523.09 | 677.50 |
| Gamma terpinene | 11 | 16.87 | 12.13 | — | 10.00 |
| Linalool | 12 | 17.88 | 100.00 | 82.42 | 82.42 |
| 1,2-Dihydrolinalool | 13 | 18.80 | 2.26 | — | 1.86 |
| alpha Terpineol | 14 | 20.60 | 4.86 | — | 4.01 |
| Decanal | 15 | 20.76 | 1.37 | — | 1.13 |
| Linalyl anthranilate | 16 | 21.95 | 274.99 | — | 226.64 |
| trans-Citral | 17 | 22.54 | 2.52 | 3.67 | 2.07 |
| Nerol acetate | 18 | 24.45 | 10.60 | — | 8.74 |
| Zingiberene | 19 | 26.42 | 2.51 | — | 2.07 |
| alpha-Farnesene | 20 | 27.68 | 3.17 | — | 2.62 |
| beta-Bisabolene | 21 | 27.89 | 5.84 | — | 4.81 |

notes:
* = actual concentration only available for compounds with relevant standard.
** = estimated concentration based on linalool standard, therefore known as ‘linalool equivelence’. Each compound, at the same concentration, will have a different response factor in mass spectrometer, hence estimated concentration.

In use as an antimicrobial, the foodstuff to be subjected to the vapour may be exposed to the accumulation of vapours for, for example, 45 seconds. This treatment results in a significant decrease in contaminating pathogens.

### EXAMPLES

The invention will now be illustrated by the following examples which are to be construed as non-limiting.

### Example 1

The screening of the vapours of the blend of bergamot (Citrus bergamia) and orange (Citrus sinensis) in a ratio of 1:1 v/v was carried out using a disc diffusion method in order to measure their ability to inhibit growth of overnight cultures (10⁸). Zones of inhibition were measured (diameter in cm).

The blend showed inhibition against Enterococcus faecium: 2.15 cm, Enterococcus faecalis: 2.18 cm, Arcobacter butzleri: 4.07 cm, Campylobacter jejuni: 1.48 cm, Escherichia coli: 0.5 cm, Listeria monocytogenes: 2.05 cm, Clostridium difficile: 2.34 cm and spores: 3.53, Staphylococcus aureus: 1.25 cm and Bacillus cereus spores: 3.97 cm.

All of the following experiments were carried out on E. faecium and E. faecalis because they are established as faecal contamination indicator species and their vancomycin resistant strains (VRE) are important hospital acquired infections. Test organisms included: Enterococcus faecalis NCTC 12697, Enterococcus faecium NCTC 07171. Vancomycin resistant strains Enterococcus faecalis NCTC 12203, Enterococcus faecium NCTC 12202.

### Example 2

Minimum Inhibitory Dose (MID) for the vapour from a blend of bergamot (Citrus bergamia) and orange (Citrus sinensis) in a ratio of 1:1 v/v was established using a vapour chamber method (Inouye, S., Takizawa, T. and Yamaguchi, H. (2001) Antibacterial activity of essential oils and their major constituents against respiratory tract pathogens by gaseous contact, Journal of Antimicrobial Chemotherapy, 47, 565-573). Aliquots (0.1 ml) of each antimicrobial were spotted onto 3 cm diameter filter paper discs (quick evaporation) in twofold dilutions of 1600, 800, 400, 200, 100 and 50 mg/L. The discs and inoculated plates (0.1 ml spread plated approximately 10⁸ cells) were placed in a 1.3 L airtight beaker, incubated at 25° C., 37° C., and 50° C. for 24 hours. The MID was the lowest concentration that inhibited bacterial growth. A control was a vapour chamber with no paper disc added.

Overall, the EO blend vapour had greater inhibition at 50° C. than at 25° C. or 37° C., with the blend being effective against E. faecium with an MID of 400 mg/l and 100 mg/l against E. faecalis, illustrating one of its use in horticultural greenhouses, due to the temperatures required to make the blend most effective.

### Example 3

MID were established by the same method as example 2 against vancomycin resistant E. faecium and E. faecalis.

The MID required to inhibit the growth of the vancomycin resistant strain E. faecalis was the same as that of the susceptible strain, but the dose required for inhibition of the E. faecium vancomycin resistant strain was reduced from 400 mg/l to 200 mg/l, demonstrating that the vapour is the same, if not better, at inhibiting the growth of antibiotic resistant bacterial strains.

### Example 4

Reduction of growth in vitro was assessed against strains (resistant and susceptible) grown in Brain Heart Infusion (BHI) broth with an initial inoculum of 10⁶ cells with the MID of the blend at either 25° C. or 37° C. or 50° C. Samples were taken at various time intervals, plated onto BHI agar and incubated for 24 hours at 37° C. Controls were growth without the presence of the vapours.

No growth was detectable in the vapour experiments at 50° C. and pH 7.5 or pH 9.5 after 48 hours, against the antibiotic susceptible strains thus demonstrating a 10 log reduction in growth, the reduction in growth became significant between 2 and 4 hours (p=0.001). The vapours only inhibited growth of the resistant strains by 4.5 log.

This example again illustrates one of the uses of the blend's vapours in environments with high temperatures such as greenhouses and the ability of the vapours to inhibit antibiotic resistant strains.

### Example 5

The use of diffusers at low temperatures was assessed in a larger space: a 600 L sealed unit. Concentrations of 5, 10, 15 and 30 mg/l of the blend of bergamot (Citrus bergamia) and orange (Citrus sinensis) in a ratio of 1:1 v/v were diffused via either a heat or fan diffuser (AMPHORA, UK). BHI agar plates adjusted to either pH 5.5, 7.5, or 9.5 were spread with 0.1 μl of overnight culture (10⁷ cfu/ml) of E. faecalis or E. faecium vancomycin resistant or susceptible strains and placed in the unit for 24 hours at either 37° C. or 25° C. and inhibition assessed.

All concentrations via the fan diffuser and 5, 10, 30 mg/l via the heat diffuser did not have any effect on growth. The combination of the heat diffuser and 15 mg/l of the blend reduced growth although complete inhibition was not observed. The use of the heat diffuser made the blend vapour an effective antimicrobial at low temperatures and also reduced the quantity of oil needed from 50 mg/l to 15 mg/l, demonstrating uses within the food/clinical arena as an antimicrobial on room/equipment sanitisation (especially as the blend vapour have been shown to be effective against spores) and processing/packing of foodstuff.

### Example 6

Assessment of growth in vitro was carried out by inoculating BHI broth with E. faecalis or E. faecium vancomycin resistant or susceptible strains (10⁶ cfu/ml) and incubating at 37° C. or 25° C. in the vapour chamber with 15 mg/l of the EO blend being diffused by the heat diffuser. Samples were taken every 15 minutes for the first hour and then hourly for eight hours and again at 24 hours. These were plated using onto BHI agar and incubated for 24 hours at 37° C. The control was the use of the diffusers without any EO blend added. The reduction in growth of all strains over 48 hours was approximately 0.5 log cfu/ml.

### Example 7

On-food vapour model using lettuce and cucumber as examples of fresh produce.

Squares of 2 cm×2 cm of iceberg lettuce and cucumber skins were taken and left under UV light for 30 minutes to remove any competing microflora. The samples were inoculated with 50 μl of an overnight culture diluted with BHI broth to 10⁵ or 10⁸ cfu/ml and left to dry for 20 minutes. The inoculated food samples were placed in a 6001 vapour chamber and subjected to the 15 mg/l of orange/bergamot blend vapour (the orange/bergamot in a ratio of 1:1 v/v) via a heat diffuser at 25° C. for 15, 30, 45, and 60 seconds after a 15 min accumulation of vapour within the chamber. Food samples were then placed in 10 ml of PBS solution, stomached for 30 seconds, plated onto BHI agar and incubated for 24 hours at 37° C. Un-inoculated samples after the initial UV sterilisation treatment were also placed in 10 ml of PBS, stomached, and plated to assess the remaining contamination levels.

The reduction of contamination of both the antibiotic resistant and susceptible strains on the lettuce and the cucumber was significantly greater at 45 seconds compared to 15, 30, and 60 seconds. Reductions at 45 seconds from 10⁵ cfu/ml and 10⁸ cfu/ml on lettuce are as follows: antibiotic susceptible E. faecium 1.4 and 4.4 Log₍₁₀₎,/ml E. faecalis 2.37 and 3.85 Log₍₁₀₎ cfu/ml and on the antibiotic resistant strains E. faecium 2.28 and 3.8 Log₍₁₀₎ cfu/ml, E. faecalis 2.03 and 3.99 Log₍₁₀₎ cfu/ml. On cucumber, the reductions in contamination from 10⁵/ml and 10⁸/ml from 45 seconds' exposure are: antibiotic susceptible E. faecium 1.58 and 3.69 Log₍₁₀₎ cfu/ml, E. faecalis 1.05 and 4.14 Log₍₁₀₎ cfu and on antibiotic resistant strains E. faecium 2.06 and 3.78 Log₍₁₀₎ cfu/ml and E. faecalis 2.02 & 3.95 Log₍₁₀₎ cfu/ml.

The results demonstrate that the vapours are effective at reducing the contamination levels of fresh foodstuffs' surfaces in a 45 second period against both antibiotic and susceptible strains at low temperatures thus having applications in the processing/packaging of fresh produce.

### Example 8

Cucumber and lettuce were exposed to 15 mg/L of the blend vapour for 45 seconds after 15 minutes accumulation of the vapour, a triangle forced choice procedure was carried out using a sensory panel consisting of a minimum of 28 participants, to see if the panel could distinguish between those foodstuffs that had been subjected to the vapours and the controls that had not, a risk was calculated with significance set at p=0.05.

There was no significant difference in the taste of the treated and untreated foodstuff with the a risk of lettuce and cucumbers being 0.62528 and 0.5157 respectively, illustrating that the use of the blend vapour on fresh produce does not affect taste.

### Example 9

Fungi screening was carried out as follows:

a) the antimicrobial vapour of a blend of bergamot (Citrus bergamia) and orange (Citrus sinensis) in a ratio of 1:1 v/v has been screened using the disc diffusion method against spores and mycelium growth against post-harvest pathogens of, Aspergillus niger (ATCC 9642), Penicillium chrysogenum (ATCC 10106) and Alternaria alternate (CABI 127255) a 100% inhibition of mycelium growth was observed against all organisms and inhibition (cm) of growth of 5.97, 5.46, and 6.22 respectively against their spores.

b) In larger spaces of 600 L the inhibition of mycelia growth when exposed to 15 mg/L air of the vapour for 15 minutes is 44% for Penicillium chrysogenum, and 67% and 34% for Aspergillus niger and Alternaria alternate respectively.

Thus, the vapour of the present invention is an effective antifungal agent against both vegetative cells and spores. The vapour therefore, has application in food growth (Greenhouses), processing and storage, to prevent fungal contamination and loss of production from post harvest pathogens.

### Example 10

MRSA Screening was carried out as follows.

The antimicrobial vapour of a blend of bergamot (Citrus bergamia) and orange (Citrus sinensis) in a ratio of 1:1 v/v has been screened using the disc diffusion method against MRSA (NCTC 13297), with an inhibition zone of 2.7 cm.

Thus, this example provides further evidence that the vapour of the present invention is effective against antibiotic resistant organisms.

### Example 11

On-surface investigations were carried out as follows.

Steel discs (2 cm diameter) were inoculated with 20 μl of overnight culture of either vancomycin susceptible or vancomycin resistant E. faecium or E. faecalis or MRSA and allowed to dry for 20 minutes. Discs were then placed in a 600 L vapour chamber and subjected to 15 mg/L air of the vapour from a blend of bergamot (Citrus bergamia) and orange (Citrus sinensis) in a ratio of 1:1 v/v via a heat diffuser for different time intervals (15 minutes, 1, 2, 4, 15, and 24 hours). The discs were then placed in 50 ml-covered beakers containing 5 g of glass beads (inoculated side of disc touching the beads) and 10 ml of PBS and shaken for 1 minute at 150 rpm. The PBS solution was then spiral plated onto BHI agar, plates incubated at 37° C. for 24 hours and viable counts determined. The controls were surfaces that had not been exposed to the orange/bergamot essential oil blend vapour.

The results showed the vapour was most effective after 24 hours' exposure with Log₍₁₀₎ reductions of 3.14, 1.45, 1.99, 1.81, and 1.78 for vancomycin susceptible E. faecalis, vancomycin susceptible E. faecium, vancomycin resistant E. faecium, vancomycin resistant E. faecalis and MRSA, respectively.

Thus, the vapour of the present invention can reduce bacterial load on surfaces in both a clinical and food arena by 99% to 99.9% against both antibiotic resistant and susceptible bacteria over 24 hours.

### Mechanisms of Action

Preliminary studies of the mechanism of action of the blends vapours have been carried out against antibiotic susceptible E. faecium and E. faecalis. The cells were assessed before and after being exposed to 15 mg/l of the blend vapour for 1 hour at 37° C. via a heat diffuser. The mechanism of action methods included:
Assessment of membrane permeability with a NPN assay.
Determination of intra and extracellular ATP concentrations using luminescence FLAA-1KT assay kit (Sigma, UK).
Influence of the blends vapours on membrane potential and intracellular pH measurements using 3,3-dipropylthiacarbocyanine and carboxyflurescein diacetate succinimidyl ester florescence respectively.
The use of transmission electron microscopy (TEM) to evaluate morphological changes to the cell.

The investigations showed that the vapours increased cell permeability by 32-40 times, the membrane potential of the cells is reduced from 35-12.61 a.u. and 45-14.97 a.u. in E. faecium and E. faecalis, respectively. Increased permeability of the cells and loss of membrane potential leads to loss of intracellular ATP in both E. faecalis and E. faecium from approximately 35 μmol/mg protein to undetectable levels. This is coupled with a decrease in intracellular pH in E. faecium from 6.34 to 5.32 pH and in E. faecalis from 6.51 to 4.25 pH. Morphological changes occur in the cells including a loss of distinction of the membrane and an elongated shape.

Without wishing to be bound by theory, the results indicate that one of the possible modes of action of citrus blend vapours against microrganisms is through increasing the permeability of the cell membrane.

It will be appreciated that the invention may be modified within the scope of the appended claims.

What is claimed is:

1. A vapour of a blend comprising the oil of orange and the oil of bergamot.

2. The vapour according to claim 1, wherein the orange oil and bergamot oil are present in the blend in a ratio of 1:1 volume:volume.

3. The vapour according to claim 1, wherein the vapour has the following major components according to GCMS:

| Components | m/z** | Counts/min |
|---|---|---|
| Methanol | 33 | 1279 |
| Ethanol | 47 | 391 |
| Acetone | 59 | 71682 |
| Isopropanol | 60 | 2236 |
| Fluoroacetic acid amine | 77 | 4505 |
| Trimethylsilyl fluoride | 92 | 58* |
| Dimethylsilanediol | 92 | 58* |
| 3-heptanone | 114 | 43 |
| Butylacetate | 116 | 110 |
| n-octanal | 128 | 57 |
| p-cymene | 134 | 342 |
| Limonene | 136 | 54440* |
| Alpha-pinene | 136 | 54440* |
| Alpha-phellandrene | 136 | 54440* |
| Camphene | 136 | 54440* |
| Thujene | 136 | 54440* |
| Beta pinene | 136 | 54440* |
| Myrcene | 136 | 54440* |
| Carene | 136 | 54440* |
| Nonanal | 142 | 36 |
| Nonanol | 144 | 36 |
| Citral | 154 | 186* |
| Linalool | 154 | 186* |
| 1-Fluorododecane | 188 | 27* |
| Bergamol | 196 | 26 |
| Linalyl isobutyrate | 224 | 25 |

*Combined peak for all components of the same molecular weight.
**m/z = mass to charge ratio

4. A process for preparing a vapour of a blend comprising the oil of orange and the oil of bergamot, the process comprising heating the blend to a temperature of 30 to 50° C. for a period of time of ranging from 10 minutes to 20 minutes, preferably for 15 minutes.

5. (canceled)

6. The vapour according to claim 1, prepared by a process comprising heating the blend to a temperature of 30 to 50° C. for a period of time of ranging from 10 minutes to 20 minutes, preferably for 15 minutes.

7. A method comprising utilizing a vapour according to claim 1 as an antimicrobial.

8. The method according to claim 7, wherein the vapour is antimicrobial against Gram-positive or Gram-negative bacteria.

9-10. (canceled)

11. The method according to claim 8, wherein the bacteria are selected from Enterococcus faecium, Enterococcus faecalis, Arcobacter butzleri, Campylobacter jejuni, Escherichia coli, Listeria monocytogenes, Clostridium difficile, Staphylococcus aureus and MRSA, wherein the Enterococcus faecium bacteria are preferably Enterococcus faecium NCTC 07171 and/or Enterococcus faecium NCTC 12202, and wherein the Enterococcus faecalis bacteria are preferably Enterococcus faecalis NCTC 12697 and/or Enterococcus faecalis NCTC 12203.

12-13. (canceled)

14. The method according to claim 8, wherein the bacteria are spore-bearing bacteria.

15. (canceled)

16. The method according to claim 14, wherein the spore-bearing bacteria are Clostridium difficile and/or Bacillus cereus.

17. The method according to claim 7, wherein the vapour is antimicrobial against fungi.

18. The method according to claim 7, wherein the antimicrobial is effective against bacteria and/or fungi present in a foodstuff.

19. The method according to claim 18, wherein the vapour is used during the processing, packaging and/or storing of the foodstuff.

20. The method according to claim 18, wherein the foodstuff is salad, vegetables and/or fruit.

21. The method according to claim 18, wherein the foodstuff is subjected to the vapour for a period of time ranging from 30 seconds to 1 minute, preferably for a period of time of 45 seconds.

22. (canceled)

23. The method according to claim 7, wherein the vapour is used for sanitisation of the air and/or equipment in a food industry or clinical environment.

24. (canceled)

25. The method according to claim 23, wherein the vapour is used for sanitisation of a surface.

26. The method according to claim 7, wherein the vapour is antimicrobial against plant pathogens.

27. The method according to claim 26, wherein the vapour is used in a greenhouse.

28-29. (canceled)

30. The vapour according to claim 1, wherein the blend consists of orange oil and bergamot oil.
